(19) United States
(12) Patent Application Publication
(10) Pub. No.: US 2026/0219878 A1
(43) Pub. Date: Jul. 30, 2026

(54) AUTOMATED DATA ENGINEERING FRAMEWORK

(71) Applicants: Premkumar Narayanaswamy, Hartford, CT (US); Vincent Martino, Hartford, CT (US); Aswin Govindarajan, Hartford, CT (US); Balachandar Kandaswamy, Hartford, CT (US)

(72) Inventors: Premkumar Narayanaswamy, Hartford, CT (US); Vincent Martino, Hartford, CT (US); Aswin Govindarajan, Hartford, CT (US); Balachandar Kandaswamy, Hartford, CT (US)

(21) Appl. No.: 19/039,898

(22) Filed: Jan. 29, 2025

(51) Int. Cl. G06F 8/71; G06F 8/77

(52) U.S. Cl. CPC G06F 8/71; G06F 8/77

(57) ABSTRACT

A data engineering framework may support data management by integrating a configuration data store with electronic records for data framework pipelines. Each pipeline includes a data source and a cloud-based storage target. The framework interfaces with the configuration data store to perform metadata setups, define new pipelines, and generate configuration files based on developer input. It also creates batch shell scripts for new pipelines, which are executed by an automated job control system to seamlessly transfer data from the source to the cloud-based target. The framework automates the data engineering development pipeline, encompassing data extraction from source systems, transformation as needed, and loading into target systems or databases. Capabilities include audit balancing checks to ensure data accuracy, automatic table creation based on predefined schemas, and ease of adoption. Notably, the framework can be deployed with minimal development effort, reducing the time and resources required to automate data engineering processes.

### TECHNICAL FIELD

The present application generally relates to computer systems and more particularly to computer systems that are adapted to accurately, securely, and/or automatically support a data engineering framework for an enterprise.

### BACKGROUND

An enterprise may build “data engineering” systems to enable the collection and usage of large amounts of data. The data might be used, for example, to enable subsequent analysis and data science (e.g., in connection with machine learning). As used herein, the phrase “data engineering” might be associated with, for example, building data pipelines to transport raw data from various sources to a final destination (e.g., a cloud data warehouse or data lake), optimizing data processing performance (e.g., to improve the time it takes to transform data, how often new data is received and how quickly updates to target destinations can be made), supporting Continuous Integration/Continuous Delivery (“CI/CD”) code building, testing, and deployment, creating data recovery plans in the event of system failures, etc.

FIG. 1 is a data engineering and Intelligent Data Management Cloud (“IDMC”) system 100. After ingesting 110 information (e.g., moving data from a source into a landing area or an object store for queries and analytics), the data may be curated 120 (e.g., for various data domains) and published 130 (e.g., via data marts and reporting data assets). A number of different factors might be considered when developing such a data engineering pipeline. FIG. 2 has some examples 200 of data engineering objectives or data engineering framework drivers 210. An improved time to market 222 might let an enterprise respond quickly and incrementally to business needs. For example, on-boarding and self-service abilities may reduce the time it takes for new developers to become productive with the appropriate tools (providing them with a better experience and decreasing the time it takes for them to start creating value).

Reusability 224 may let a developer create once and consume everywhere. Cost efficiency 226 may result in reduced development and infrastructure cost by providing a standardized set of tools and services for all teams, reducing the risk of inconsistencies and errors. Moreover, the system should be flexible 228 for complex business requirements. For example, the system may help automate setting up and managing development environments, configuring build pipelines, and deploying applications (letting developers focus on writing code and delivering features faster. Collaboration may provide a shared platform for development teams and other parts of the organization, such as operations and security teams, to work together (improving communication). Scalability 230 may provide a platform that can grow with the organization and handle large volumes during peak load. A pipeline may also encourage improved governance by establishing a framework that lets organizations adhere to best practices that comply with security and compliance requirements.

It can be very difficult, however, to meet these objectives when creating a data engineering pipeline. For example, it might be especially time consuming when there are a substantial number of data sources, data targets, types of data, etc. that need to be supported. It would be desirable to provide improved systems and methods to accurately and/or automatically support a data engineering framework for an enterprise. Moreover, the results should be easy to access, understand, interpret, update, etc.

### SUMMARY OF THE INVENTION

According to some embodiments, systems, methods, apparatus, computer program code and means are provided to accurately and/or automatically support a data engineering framework for an enterprise in a way that provides fast, secure, and useful results and that allows for flexibility and effectiveness when responding to those results.

Some embodiments are directed to a data engineering framework for an enterprise with a configuration data store that contains electronic records associated with data framework pipelines including, for each pipeline, a data source and a cloud-based storage target. A data engineering tool, coupled to the configuration data store, may perform a metadata setup to define a new pipeline to be implemented and create at least one configuration file for the new pipeline based on developer input. The data engineering tool may also create a batch shell script for the new pipeline based on the metadata setup and the configuration file. The configuration data store is updated, and an automated job control system executes the batch shell script such that data is automatically moved from the data source to the cloud-based storage target.

Some embodiments comprise: means for performing, by a back-end application computer server associated with a data engineering tool, a metadata setup to define a new pipeline to be implemented; means for creating at least one configuration file for the new pipeline based on developer input; means for creating a batch shell script for the new pipeline based on the metadata setup and the configuration file; means for updating a configuration data store that contains electronic records associated with data framework pipelines including, for each pipeline, a data source and a cloud-based storage target; and means for executing, by an automated job control system, the batch shell script such that data is automatically moved from the data source to the cloud-based storage target.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized support of data engineering that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a data engineering and Intelligent Data Management Cloud (“IDMC”) system.

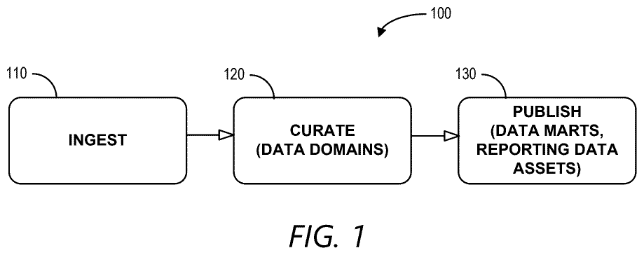

FIG. 2 has some examples of data engineering objectives.

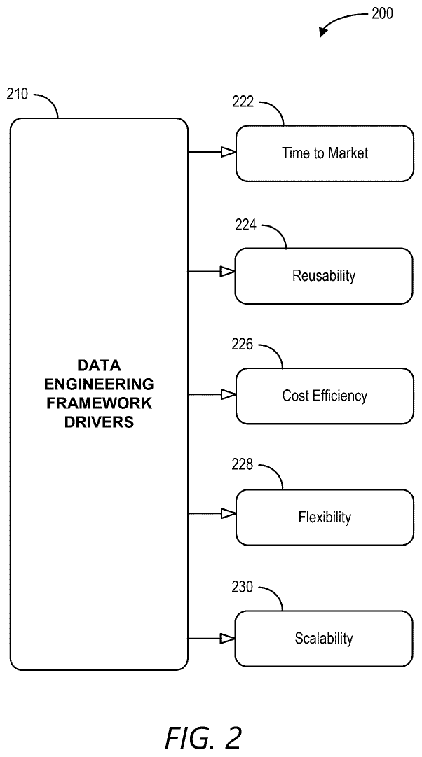

FIG. 3 is a high-level block diagram of an enterprise system in accordance with some embodiments.

FIG. 4 is a data engineering method according to some embodiments.

FIG. 5 is a data engineering process in accordance with some embodiments.

FIG. 6 is a data engineering batch process according to some embodiments.

FIG. 7 shows data engineering framework code modularity in accordance with some embodiments.

FIG. 8 is a data engineering architecture according to some embodiments.

FIG. 9 is framework and application setup in accordance with some embodiments.

FIG. 10 is a change management process supporting multiple organizations according to some embodiments.

FIG. 11 is a data engineering framework in accordance with some embodiments.

FIG. 12 shows data loss examples according to some embodiments.

FIG. 13 is a Character Large Object (“CLOB”) extraction in accordance with some embodiments.

FIG. 14 is a data engineering framework operator or administrator display according to some embodiments.

FIG. 15 is a block diagram of an apparatus in accordance with some embodiments.

FIG. 16 is a portion of a configuration database according to some embodiments.

FIG. 17 is a tablet computer according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with a data engineering framework. The present invention is directed to more than merely a computer implementation of a routine or conventional activity previously known in the industry as it provides a specific advancement in the area of data engineering by providing improvements in the operation of a computer system that automatically implements appropriate data engineering configurations. The present invention provides improvement beyond a mere generic computer implementation as it involves the novel ordered combination of system elements and processes to provide improvements in the speed, security, and accuracy of such a data engineering tool for an enterprise. Some embodiments of the present invention are directed to a system adapted to automatically handle third-party data, aggregate information from multiple data sources, automatically generate pipelines in a way that reduces unnecessary messages or communications, etc. (e.g., to consolidate communications between parties within an enterprise). Moreover, communication links and messages may be automatically established, aggregated, formatted, modified, removed, exchanged, etc. to improve network performance (e.g., by reducing an amount of network messaging bandwidth and/or storage required to create allocation workflows or alerts, improve security, reduce the size of data stores, more efficiently collect, present, and utilize data engineering information and results, etc.).

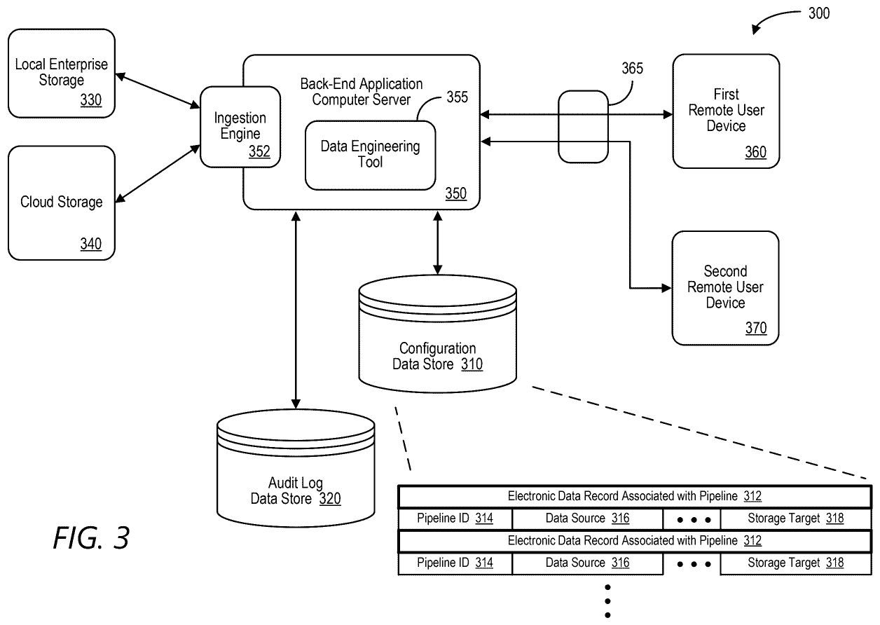

FIG. 3 is a high-level block diagram of an enterprise system 300 that may be provided according to some embodiments of the present invention. In particular, the system 300 includes a back-end application computer server 350 that may access information in a configuration data store 310 (e.g., storing a set of electronic records associated with pipelines 312, each record including, for example, one or more pipeline identifiers 314, data sources 316, storage targets 318, etc.). The back-end application computer server 350 may also store information into other data stores, such as an audit log data store 320, and utilize an ingestion engine 352 and a data engineering tool 355 to exchange and process messages and view, analyze, and/or update electronic records. The back-end application computer server 350 may also exchange information with a first remote user device 360 and a second remote user device 370 (e.g., via a firewall 365). According to some embodiments, an interactive graphical user interface platform of the back-end application computer server 350 may facilitate the creation and review of data engineering information, recommendations, alerts, and/or the display of results via one or more remote administrator computers (e.g., to summarize system 300 performance) and/or the remote user devices 360, 370. For example, the first remote user device 360 may transmit annotated and/or updated information to the back-end application computer server 350. Based on the updated information, the back-end application computer server 350 may adjust data in the configuration data store 310 and the changes may (or may not) be used in connection with the second remote user device 370.

Note that the back-end application computer server 350 and/or any of the other devices and methods described herein might be associated with a third party, such as a vendor that performs a service for an enterprise. In some cases, the computer server 350 may receive information (e.g., configuration metadata) in connection with a spreadsheet application (e.g., the MICROSOFT™ EXCEL® spreadsheet application). Moreover, the computer server 350 may ingest, curate, and/or publish information via Python and/or PySpark (the Python API for the Apache Spark that provides a distributed computing framework for large-scale data processing) in accordance with enterprise defined metadata.

The back-end application computer server 350 and/or the other elements of the system 300 might be, for example, associated with a Personal Computer (“PC”), laptop computer, smartphone, an enterprise server, a server farm, and/or a database or similar storage devices. According to some embodiments, an “automated” back-end application computer server 350 (and/or other elements of the system 300) may facilitate the automated access and/or update of electronic records in the data stores 310, 320 and/or the automated management of data engineering (e.g., via workflow, calendar, and/or accounting servers). As used herein, the term “automated” may refer to, for example, actions that can be performed with little (or no) intervention by a human.

Devices, including those associated with the back-end application computer server 350 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 350 may store information into and/or retrieve information from the configuration data store 310, the audit log data store 320, local enterprise storage 330, cloud storage 340, etc. The data stores 310, 320 may be locally stored or reside remote from the back-end application computer server 350. As will be described further below, the configuration data store 310 may be used by the back-end application computer server 350 in connection with an interactive user interface to facilitate data engineering for an enterprise. Although a single back-end application computer server 350 is shown in FIG. 3, any number of such devices may be included. Moreover, various devices described herein might be combined according to embodiments of the present invention. For example, in some embodiments, the back-end application computer server 350 and configuration data store 310 might be co-located and/or may comprise a single apparatus.

The system 300 may support data integration to collect and import data from various sources, including databases, APIs, streaming platforms and files. The system 300 may also support robust data acquisition, enabling seamless connections to databases such as ORACLE™, MS SQL, SNOWFLAKE® and PostgreSQL. Embodiments may further support any database that uses Java Database Connectivity (“JDBC”) or Open Database Connectivity (“ODBC”) connections. The system 300 may support cloud storage solutions (e.g., AWS® S3) for efficient data retrieval and storage and additional sources and cloud services may be configured with minimal effort, allowing for easy enhancement and scalability. In some embodiments, the system 300 supports database operations to facilitate data transfer between database tables using metadata and offers filtering capabilities for data extraction from source tables. The system 300 may further provide tools for cleansing, transforming, and/or enriching data to enhance usability for analysis and reporting.

The scalability and performance of the system 300 may improve compute utilization by implementing resources mainly using cloud services (enhancing processing capabilities). Multi-threading may be supported by the system 300 via processes that use multiple threads to improve performance and efficiency. User-defined compute options may let users specify the use of specific compute resources (or multi-thread execution) based on their requirements. The system 300 may provide serverless EMR support including utilities and orchestration support to leverage serverless EMR for compute, providing scalable and cost-effective processing. Large data handling by the system 300 may efficiently manage large volumes of data, ensuring that the framework can scale to meet growing data demands. Moreover, performance optimization for both batch and real-time data processing may be provided, ensuring timely and efficient data operations. Further, the system 300 may provide high availability and fault tolerance to ensure that the framework is highly available and resilient to failures (supporting continuous and reliable service).

The system 300 may support security and compliance by using robust encryption methods to protect data, ensuring that sensitive information is secure. A disaster recovery mechanisms may ensure data and system recovery in the event of failures or data loss (maintaining business continuity). Further, role-cased access controls for metadata management may be supported, ensuring that only authorized personnel can access and manage metadata. The system 300 may support detailed logging and monitoring for security audits, ensuring that all data operations are tracked and auditable.

The elements of the system 300 may work together to perform the various embodiments of the present invention. Note that the system 300 of FIG. 3 is provided only as an example, and embodiments may be associated with additional elements or components. According to some embodiments, the elements of the system 300 automatically transmit information associated with an interactive user interface display over a distributed communication network.

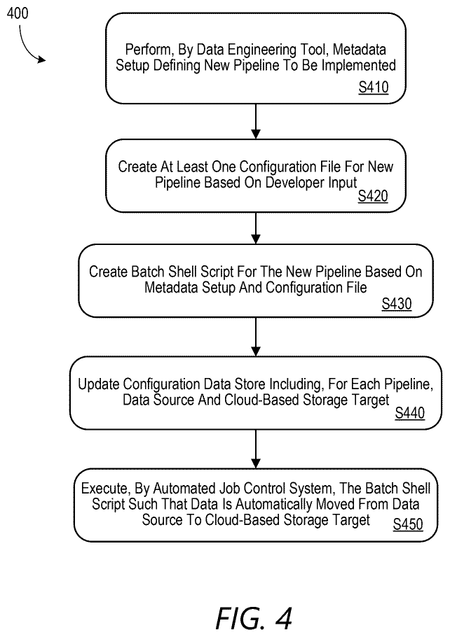

FIG. 4 is a data engineering method 400 that might be performed by some or all of the elements of the system 300 described with respect to FIG. 3, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S410, a computer processor of a data engineering tool performs a metadata setup to define a new pipeline to be implemented for an enterprise. The system may then create at least one configuration file for the new pipeline based on developer input at S420. In some embodiments, the configuration file includes a table to capture the entity level details for the pipeline including the data source cloud-based storage target. Embodiments may also include tables with Structure Query Language (“SQL”) queries to be executed at runtime, schema level details (including a column name, a datatype, and a precision), runtime details captured for Change Data Capture (“CDC”) operations, runtime error details, etc.

With respect to CDC, the framework may identify changes in source and target tables to keep data up-to-date. Type 2 changes may be implemented by marking existing records as “expired” and activating new records when source data changes. This might include support for Slowly Changing Dimensions (“SCD”) and/or hash key generation. The framework may support both truncating and loading tables or performing incremental loads and identify and manage duplicate data in tables. Historical data for audit and compliance purposes (as well as for consumer needs) may be maintained, ensuring a comprehensive data history is preserved.

At S430, a batch shell script is created for the new pipeline based on the metadata setup and the configuration file. At S440, a configuration data store is updated, and an automated job control system can execute the batch shell script such that data is automatically moved from the data source to the cloud-based storage target at S450.

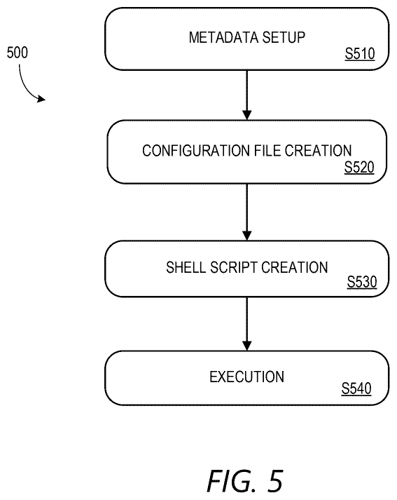

FIG. 5 is a data engineering process 500 in accordance with some embodiments. Metadata setup at S510 defines the processes being implemented and recorded in cloud-based data storage that allows for data analysis and simultaneous access of data sets with minimal latency (e.g., SNOWFLAKE®). Configuration file creation at S520 might, for example, utilize a human-readable data serialization language such as YAML with all of the source and target connectivity details. Shell script creation at S530 defines the functionality needed to get data from point A to point B. During execution at S540, a workload automation may provide visibility and control of complex workloads across platforms, Enterprise Resource Planning (“ERP”) systems, and the cloud, such as the BROADCOM INC.® AUTOSYS™ automation. AUTOSYS™ jobs can be created for the shell scripts to automatically move information from the data source to the cloud-based storage target.

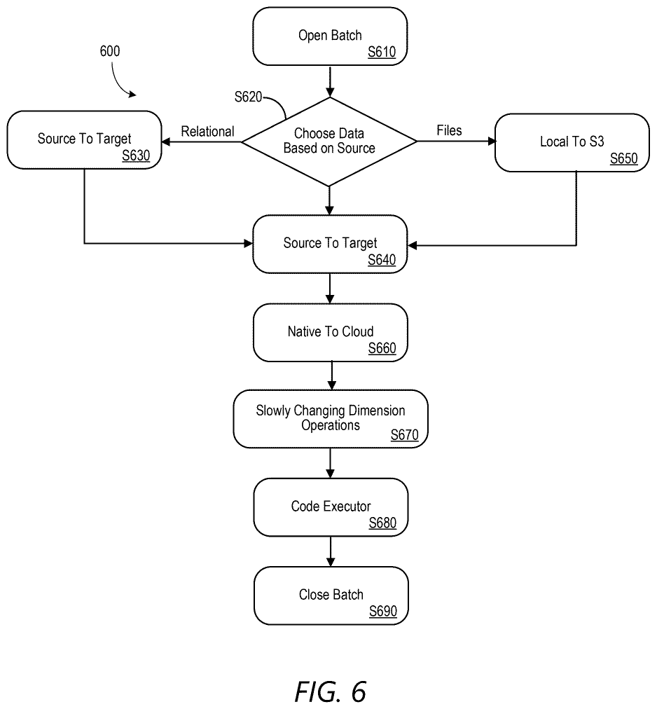

In some embodiments information is automatically moved information from the data source to the cloud-based storage target via a storage native. For example, FIG. 6 is a more detailed data engineering batch process 600 according to some embodiments. After a batch is opened at S610, a data source is determined at S620. For relational data, source to target imports data from a database and places it in a Simple Storage Service (“S3”) landing at S630 before completing the source to target at S640 (copying from the landing to native and converting the file type as needed). For files, local to S3 copies the data from local via a Hadoop Distributed File System (“HDFS”) at S650 before completing the source to target at S640 (copying from the landing to native and converting the file type as needed). At S660 native to cloud copies the information, such as into a SNOWFLAKE® internal table. At S670, Slowly Changing Dimensions Type 2 (“SCD2”) operations are performed (e.g., hashing, dating, etc.). Code Executor at S680 executes the code query as part of curate, and the batch is closed at S690.

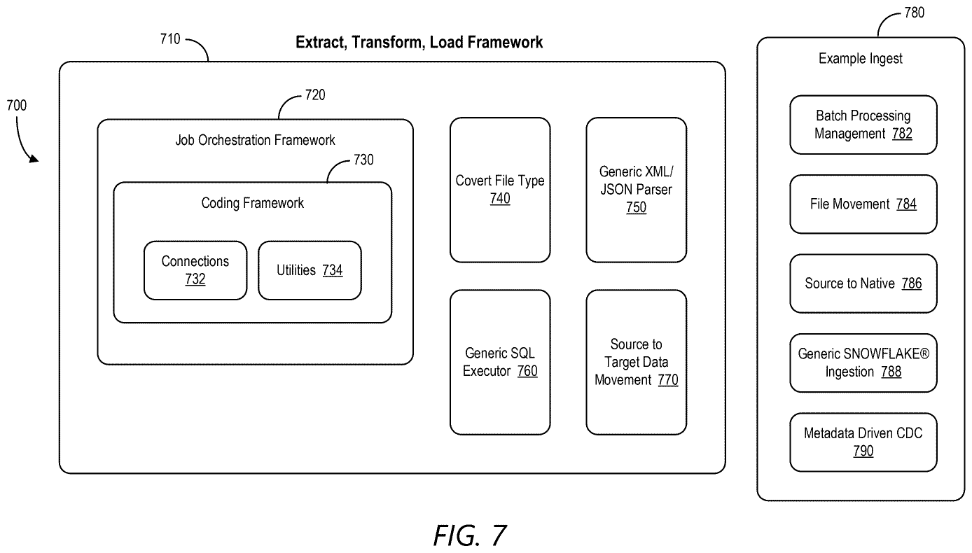

FIG. 7 shows data engineering framework 700 code modularity in accordance with some embodiments. An Extract, Transform, Load (“ETL”) framework 710 includes a job orchestration framework 720 with a coding framework 730 with connections 732 (e.g., SNOWFLAKE®, ORACLE®, generic Java Database Connectivity (“JDBC”), S3 etc.) and utilities 734 (e.g., logging, configuration files, semi-structured data parser, encrypt/decrypt etc.). The ETL framework 710 may also include file type conversion 740, a generic XML/JSON parser 750, a generic SQL executor 760, source to target data movement 770, etc. Ingestion examples 780 include batch processing management 782, file movement 784, source to native 786, generic SNOWFLAKE® ingestion 788, metadata driven CDC 790, etc.

The framework 700 may use a microservices-based architecture to offer several advantages, such as rapid development allowing for aster addition of new capabilities due to the modular nature of the architecture. The framework 700 may improve speed-to-market by accelerating development and deployment processes for new features. A data catalogue may be designed to integrate with data cataloguing tools, such as those associated with an Intelligent Data Management Cloud (“IDMC”), to create/enhance data lineage, data profiling, and metadata management using metadata information stored in the framework 700. Enhanced data management may improve data lineage, cataloging, profiling, and quality assessments. In addition, the framework 700 may provide robust governance practices through centralized cataloging and quality assessments.

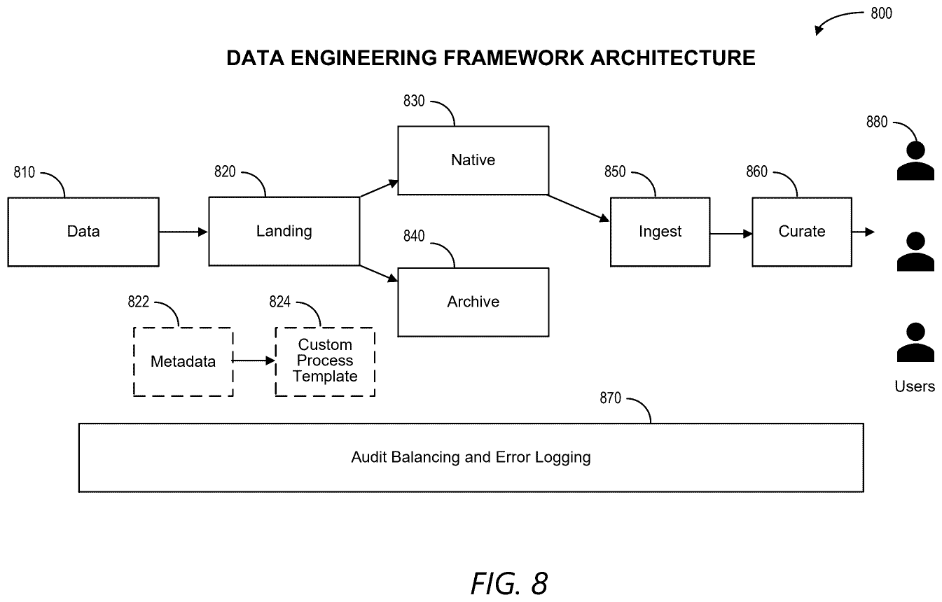

FIG. 8 is a data engineering architecture 800 according to some embodiments. Data 810 (e.g., SQL, JDBC, ORACLE®) is sent to landing 820 via a raw load. The information in landing 820 is compressed and stored in archive 840. The information in landing 820 is also cleansed and stored in native 830 (using metadata 822 and custom process templets 824). After the information from native 830 is ingested 850 and curated 860, it can be provided to users 880. Audit balancing and error logging 870 may also be supported.

For example, Audit Balancing and Controls (“ABC”) checks may have comprehensive mechanisms to ensure data integrity, reliability, and transparency throughout the data processing lifecycle. Error logging (such as file system logging) may capture and log errors related to file operations, providing detailed information about file transfer, archiving, and timestamping issues. Database logging may record errors encountered during database operations, including data transfer, filtering, and change detection (ensuring that all anomalies are recorded for debugging and troubleshooting). Automatically triggered notifications may be transmitted to a designated distribution group when errors or significant events occur, ensuring timely awareness and response. The framework may allow for customization of alert thresholds and conditions (providing flexibility in monitoring and managing data processes). Moreover, process recovery may have the capability to restart processes from the point of failure, minimizing downtime and ensuring continuity in data operations. The framework may implement performance evaluations using run time information (e.g., to provide detailed information about the total run time of data processes to help identify performance bottlenecks and optimize operations) and/or cost evaluations associated with data processing tasks (offering insights into resource utilization and enabling cost-effective management).

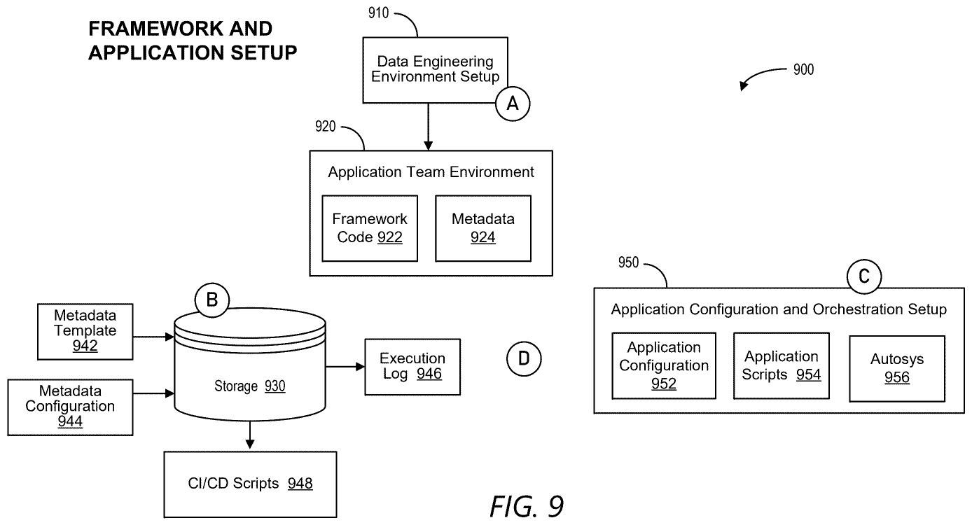

FIG. 9 is framework and application setup 900 in accordance with some embodiments. At (A), data engineering environment setup 910 interacts with an application team environment 920 (including framework code 922 and metadata 924). At (B), storage 930 receives metadata template information 942 (e.g., EXCEL®) and metadata configuration information 944 (e.g., YAML) and outputs an execution log 946 and CI/CD scripts 948. At (C), application configuration and orchestration setup 950 may utilize application configuration information 952, application scripts 954, and/or AUTOSYS® 956 before the ingestion jobs are executed at (D).

Metadata management and configuration may be SQL-driven and can be executed through metadata, providing a flexible and powerful way to manage data operations. Metadata storage may capture and store batch, job, and process-level metadata (including operation and status) ensuring comprehensive tracking of data operations. Database object storage may be implemented for table creation, ensuring that all necessary objects are available and easily accessible. Data lineage information may offer ways to capture and store data lineage information, providing transparency and traceability of data transformations. Metadata archiving: may provide backup for recovery and audit purposes, ensuring that historical metadata is preserved and accessible. In addition, embodiments may store actual code (e.g., SQL and procedures) in metadata tables for execution, providing a centralized and efficient way to manage and execute code.

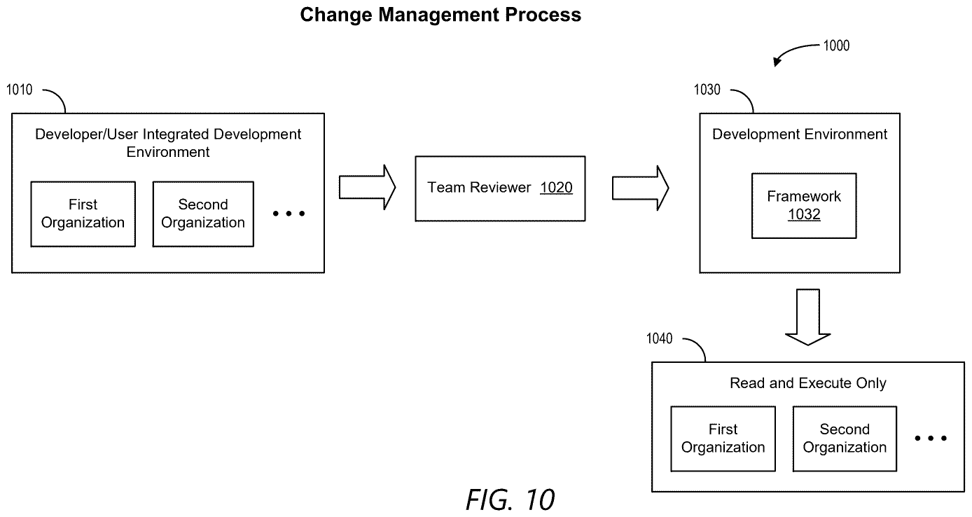

An enterprise might include multiple organizations (e.g., business units) that utilize a data engineering framework. For example, FIG. 10 is a change management process 1000 supporting multiple organizations according to some embodiments. A developer/Integrated Development Environment (“IDE”) 1010 may receive contributions from various organizations within an enterprise. After being reviewed 1020 (e.g., initiated via Git check-in), the contributions are provided to a development environment 1030 with a framework 1032 (e.g., via a Git commit). The contributions are then available to the various organizations via read and execute only 1040.

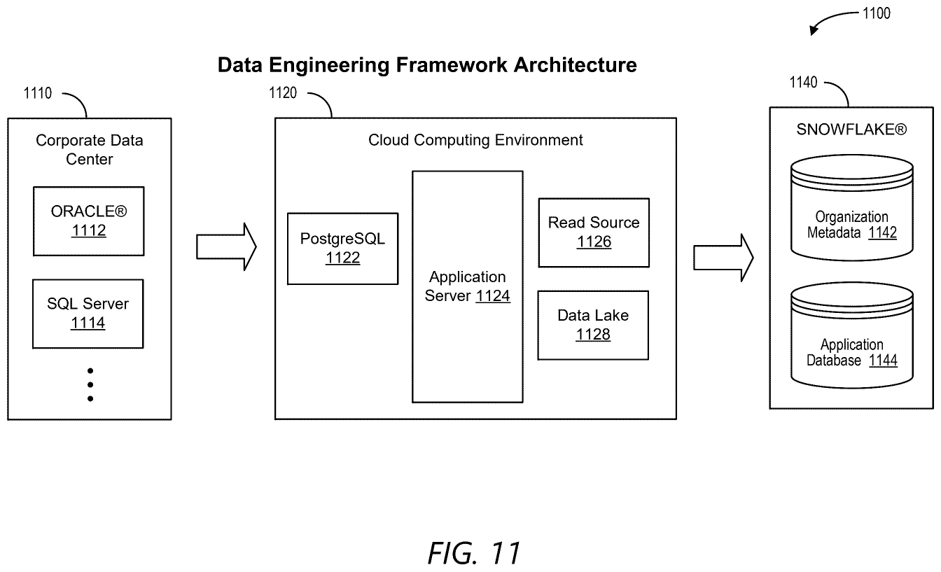

FIG. 11 is a data engineering framework 1100 in accordance with some embodiments. Information from a corporate data center 1110 (e.g., ORACLE® 1112, SQL server 1114, etc.) is provided to a cloud computing environment 1120 with a PostgreSQL 1122 and application server 1124 (e.g., to create batch, load tables, perform SCD2 operations, close batch, etc.). In some embodiments, read source 1126 and data lake 1128 are used to write information into SNOWFLAKE® 1140, such as organization metadata 1142 and/or an application database 1144.

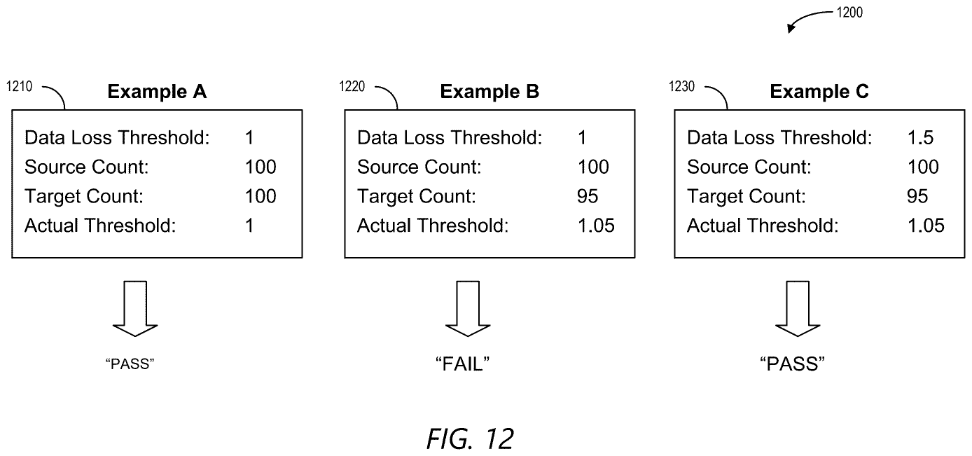

According to some embodiments, the data engineering tool is further to calculate a data loss status for the pipeline. Note that in some cases, a relatively small amount of data loss may be acceptable. FIG. 12 shows data loss examples 1200 according to some embodiments. In example A 1210, a data loss threshold of “1” is established (requiring 0% data loss). A total of 100 items are read from a data source and a total of 100 items are provided to a data target. The actual threshold may be calculated as follows:

$$actual threshold = \frac{Source Count}{Target Count}$$

resulting in an actual threshold of 1. As a result, example A 1210 results in a “PASS” output (the requirement is met so nothing further needs to be done.

In example B 1220, a data loss threshold of “1” is established (requiring 0% data loss). A total of 100 items are read from a data source but only 95 of those 100 items are provided to a data target. The actual threshold is now 1.05 resulting in a “FAIL” being output for example B 1220 (meaning that a resolution to the problem is required). In example C 1230, a data loss threshold of “1.5” is established. Once again. a total of 100 items are read from a data source but only 95 of the 100 items are provided to a data target. The actual threshold is again 1.05 resulting in a “PASS” being output for example C 1230 (meaning that no resolution is required because the data loss is “good enough”). In this way, a framework may perform data reconciliation by comparing source and target datasets, ensuring consistency and accuracy. Moreover, embodiments may let an operator or administrator set thresholds for data reconciliation (enabling automated checks and alerts when discrepancies exceed acceptable limits).

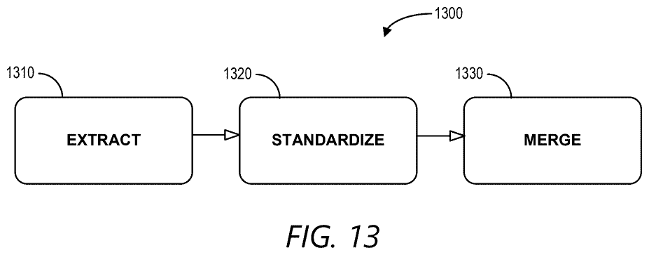

Some data engineering framework embodiments support unstructured data such as Character Large Object (“CLOB”) information. A CLOB may be used, for example, to store Unicode character-based data (such as large documents in any character set). Moreover, some embodiments support CLOB extraction to XML/JSON. For example, FIG. 13 is a CLOB extraction 1300 in accordance with some embodiments. At 1310, the system extracts (e.g., from ORACLE®, SQL server, etc.) a CLOB column from a table/moves files from S3 and creates XML/JSON file. At 1320, a cloud computing environment standardizes the XML and converts it to JSON (adding keys based on needs). At 1330, SNOWFLAKE® may be used to merge multiple small JSON files to a recommended size for optimal ingestion.

In this way, embodiments may improve the ease of use of data engineering pipelines, letting developers seamlessly switch between compute types (e.g., Python and PySpark) using low code or no code capabilities. Embodiments may use a metadata driven architecture with tables to enter metadata details. This approach may improve reusability (with a single, versatile codebase that addresses most use cases), accelerate development, and substantially reduce development/deployment times. A microprocessor microservice design lets developers add new processes and connections (such as adding new source or target databases) and achieve process decoupling (new functionality can be introduced without the risk of impacting existing features). A framework may support continuous delivery pipelines for faster development and easier maintenance and/or provide mechanisms to deploy code across environments (e.g., DEV, QA, and PROD). Embodiments may execute tasks through external scheduling tools such as AutoSys, providing flexibility in task management and scheduling and include version control mechanisms for managing code changes.

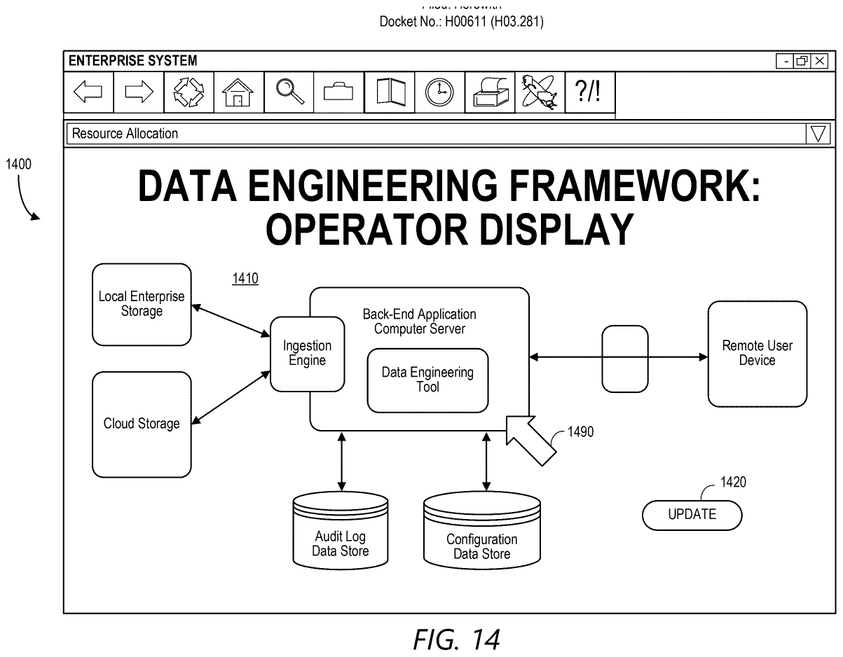

The operation of an enterprise data engineering framework may be controlled via a Graphical User Interface (“GUI”). For example, FIG. 14 is an enterprise data engineering framework operator or administrator display 1400 including graphical representations of elements of such a tool 1410 according to some embodiments. Selection of a portion or element of the display 1400 via a touchscreen or pointer 1490 might result in the presentation of additional information about that portion or element (e.g., a popup window presenting data mappings, data loss thresholds, etc.) or let an operator or administrator enter or annotate additional information about data engineering (e.g., based on changes to system configuration, pipeline results, etc.). An “Update” icon 1420 might let the administrator save updates and changes to the tool 1410.

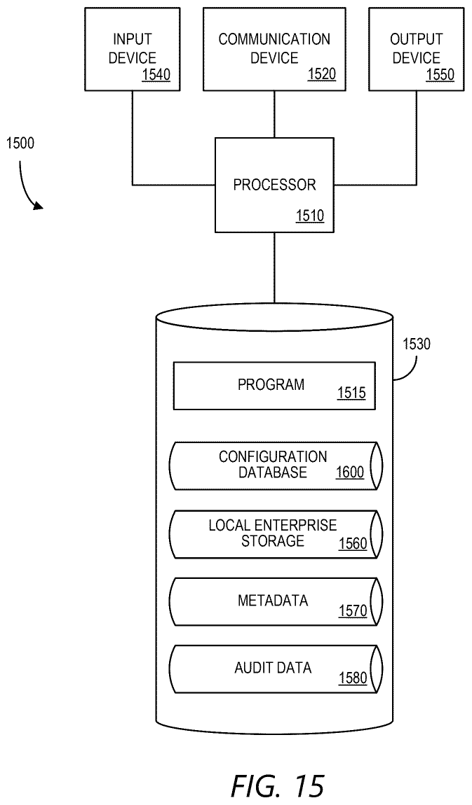

The embodiments described herein may be implemented using any number of different hardware configurations. For example, FIG. 15 illustrates an apparatus 1500 that may be, for example, associated with the enterprise data engineering system 300 described with respect to FIG. 3 (or any other system described herein). The apparatus 1500 comprises a processor 1510, such as one or more commercially available Central Processing Units (“CPUs”) in the form of one-chip microprocessors, coupled to a communication device 1520 configured to communicate via a communication network (not shown in FIG. 15). The communication device 1520 may be used to communicate, for example, with one or more remote cloud or on-premises systems, administrators, pipeline developers, enterprise employees, and/or other communication devices (e.g., PCs and smartphones). Note that communications exchanged via the communication device 1520 may utilize security features, such as those between a public internet user and an internal network of an insurance company and/or an enterprise. The security features might be associated with, for example, web servers, firewalls, and/or PCI infrastructure. The apparatus 1500 further includes an input device 1540 (e.g., a mouse and/or keyboard to enter information about data engineering, data loss thresholds, etc.) and an output device 1550 (e.g., to output reports regarding data engineering, recommendations, alerts, etc.).

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1515 and/or a data engineering tool or application for controlling the processor 1510. The processor 1510 performs instructions of the program 1515, and thereby operates in accordance with any of the embodiments described herein. For example, the processor 1510 may perform a metadata setup to define a new pipeline to be implemented and create at least one configuration file for the new pipeline based on developer input. The processor 1510 might also create a batch shell script for the new pipeline based on the metadata setup and the configuration file. The processor 1510 may then arrange for an automated job control system to execute the batch shell script such that data is automatically moved from the data source to the cloud-based storage target.

The program 1515 may be stored in a compressed, uncompiled and/or encrypted format. The program 1515 may furthermore include other program elements, such as an operating system, a database management system, and/or device drivers used by the processor 1510 to interface with peripheral devices.

As used herein, information may be “received” by or “transmitted” to, for example: (i) the apparatus 1500 from another device; or (ii) a software application or module within the apparatus 1500 from another software application, module, or any other source.

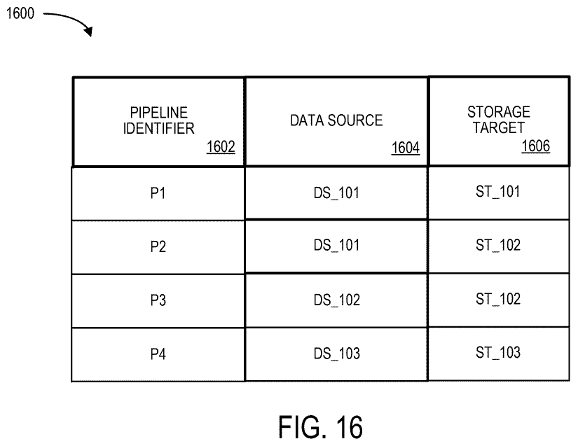

In some embodiments (such as shown in FIG. 15), the storage device 1530 further includes a configuration database 1600, local enterprise storage 1560, metadata 1570, and audit data 1580 (e.g., an error log). An example of a database that might be used in connection with the apparatus 1500 will now be described in detail with respect to FIG. 16. Note that the database described herein is only an example, and additional and/or different information may be stored therein. Moreover, various databases might be split or combined in accordance with any of the embodiments described herein. For example, the configuration database 1600 and the metadata 1570 might be combined and/or linked to each other within the program 1515.

Referring to FIG. 16, a table is shown that represents the configuration database 1600 that may be stored at the apparatus 1500 according to some embodiments. The table may include, for example, entries associated with various data engineering pipelines utilized by an enterprise. The table may also define fields 1602, 1604, 1606 for each of the entries. The fields 1602, 1604, 1606 may, according to some embodiments, specify: a pipeline identifier 1602, a data source 1604, and a storage target 1606. The configuration database 1600 may be created and updated, for example, when developer inputs are defined or adjusted, a pipeline is added or removed, etc.

The pipeline identifier 1602 may be, for example, a unique alphanumeric code associated with a particular data engineering pipeline. The data source 1604 indicates where the information or “big data” is coming from (e.g., ORACLE®, SQL server, etc.). As used herein, the phrase “big data” may refer to, for example, large and complex sets of data that are difficult to manage and analyze with traditional data processing tools. Big data can include structured, semi-structured, and unstructured data from a wide range of sources and formats. Note that embodiments may handle and process unstructured data by connecting to various messaging queues and extracting unstructured data such as XML and JSON. The framework may convert data from one format to another (such as by converting XML to JSON format). It may facilitate the parsing of unstructured data into structured formats, such as tables or views, enhancing readability and usability. The storage target 1606 indicates where the information is going to (e.g., SNOWFLAKE®).

Thus, embodiments may continuously monitor, recommend, and/or automatically implement data engineering for an enterprise. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications. Embodiments may also support file management via utilities for transferring files across various folders and file systems (optionally including functionality to archive and timestamp files).

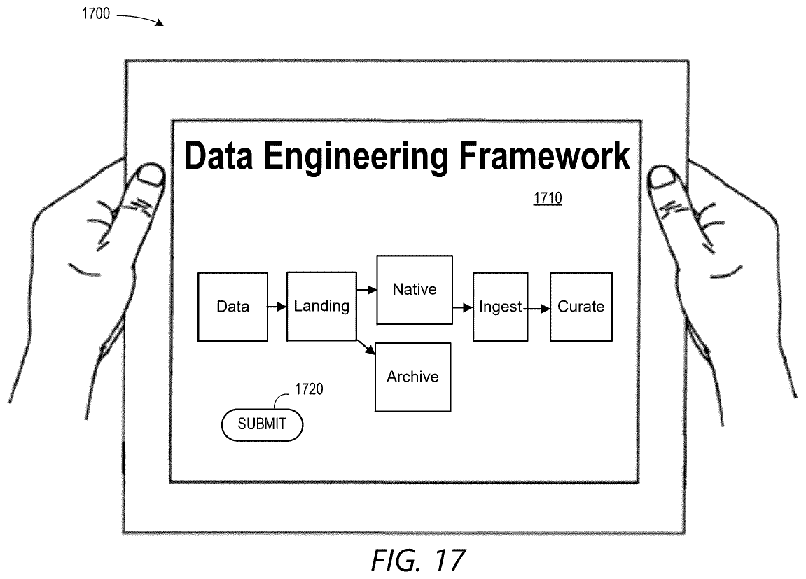

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of financial enterprises, educational institutions, organizations, etc. instead. FIG. 17 illustrates a handheld tablet 1700 in accordance with some embodiments. A data engineering tool display 1710 might, for example, let an operator review, modify or implement pipeline configurations associated with an enterprise via a “Submit” icon 1720.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A data engineering system for an enterprise, comprising:
(a) a configuration data store that contains electronic records associated with data framework pipelines including, for each pipeline, a data source and a cloud-based storage target; and
(b) a data engineering tool, coupled to the configuration data store, including:
a computer processor, and
a computer memory coupled to the computer processor and storing instructions that, when executed by the computer processor, cause a back-end application computer server associated with the data engineering tool to:
perform a metadata setup to define a new pipeline to be implemented,
create at least one configuration file for the new pipeline based on developer input,
create a batch shell script for the new pipeline based on the metadata setup and the configuration file,
update the configuration data store, and
execute, by an automated job control system, the batch shell script such that data is automatically moved from the data source to the cloud-based storage target.

2. The system of claim 1, wherein the configuration file includes a table to capture entity level details for the pipeline including the data source cloud-based storage target.

3. The system of claim 1, wherein the configuration file includes a table with Structure Query Language (“SQL”) queries to be executed at runtime.

4. The system of claim 1, wherein the configuration file includes a table with schema level details including a column name, a datatype, and a precision.

5. The system of claim 1, wherein the configuration file includes a table with runtime details captured for Change Data Capture (“CDC”) operations.

6. The system of claim 1, wherein the configuration file includes a table with runtime error details.

7. The system of claim 1, wherein the data engineering tool is further to calculate a data loss status for the pipeline.

8. The system of claim 1, wherein the data is automatically moved from the data source to the cloud-based storage target via a storage native.

9. The system of claim 8, wherein files are copied from local sources to the cloud-based storage target via a Hadoop Distributed File System (“HDFS”).

10. The system of claim 8, wherein data imported from a relational database is stored in the cloud-based storage target.

11. The system of claim 1, wherein information in the cloud-based storage target is associated with curated data domains and publishing.

12. A data engineering method for an enterprise, comprising:
performing, by a back-end application computer server associated with a data engineering tool, a metadata setup to define a new pipeline to be implemented;
creating at least one configuration file for the new pipeline based on developer input;
creating a batch shell script for the new pipeline based on the metadata setup and the configuration file;
updating a configuration data store that contains electronic records associated with data framework pipelines including, for each pipeline, a data source and a cloud-based storage target; and
executing, by an automated job control system, the batch shell script such that data is automatically moved from the data source to the cloud-based storage target.

13. The method of claim 12, wherein the configuration file includes a table to capture entity level details for the pipeline including the data source cloud-based storage target.

14. The method of claim 12, wherein the configuration file includes a table with Structure Query Language (“SQL”) queries to be executed at runtime.

15. The method of claim 12, wherein the configuration file includes a table with schema level details including a column name, a datatype, and a precision.

16. The method of claim 12, wherein the configuration file includes a table with runtime details captured for Change Data Capture (“CDC”) operations.

17. The method of claim 12, wherein the configuration file includes a table with runtime error details.

18. A non-transitory, computer-readable medium storing instructions, that, when executed by a processor, cause the processor to perform a data engineering method for an enterprise, the method comprising:
performing, by a back-end application computer server associated with a data engineering tool, a metadata setup to define a new pipeline to be implemented;
creating at least one configuration file for the new pipeline based on developer input;
creating a batch shell script for the new pipeline based on the metadata setup and the configuration file;
updating a configuration data store that contains electronic records associated with data framework pipelines including, for each pipeline, a data source and a cloud-based storage target; and
executing, by an automated job control system, the batch shell script such that data is automatically moved from the data source to the cloud-based storage target.

19. The medium of claim 18, wherein the data engineering tool is further to calculate a data loss status for the pipeline.

20. The medium of claim 19, wherein the data is automatically moved from the data source to the cloud-based storage target via a storage native.

21. The medium of claim 20, wherein files are copied from local sources to the cloud-based storage target via a Hadoop Distributed File System (“HDFS”).

22. The medium of claim 20, wherein data imported from a relational database is stored in the cloud-based storage target.

23. The medium of claim 18, wherein information in the cloud-based storage target is associated with curated data domains and publishing.
